(19) United States
(12) Patent Application Publication
(10) Pub. No.: US 2025/0362490 A1
(43) Pub. Date: Nov. 27, 2025

(54) PROGRAMMABLE FREEFORM OPTICS FOR HEAD-UP DISPLAY SYSTEM

(71) Applicant: GM GLOBAL TECHNOLOGY OPERATIONS LLC., Detroit, MI (US)

(72) Inventors: Kai-Han Chang, Madison Heights, MI (US); Thomas A. Seder, Fraser, MI (US)

(73) Assignee: GM GLOBAL TECHNOLOGY OPERATIONS LLC, Detroit, MI (US)

(21) Appl. No.: 18/669,725

(22) Filed: May 21, 2024

(51) Int. Cl. G02B 26/08; G02B 27/01

(52) U.S. Cl. CPC G02B 26/0825; G02B 27/0101

(57) ABSTRACT

A head-up display (HUD) system is calibrated via a method for use with a windshield having a predetermined curvature and rake angle includes a HUD projector, a programmable freeform optics (PFO) device, and a fold mirror. The projector is configured to project an input image along a primary light transmission path. The PFO device is positioned in the primary light transmission path and reflects or transmits the input image along a secondary light transmission path as an output image. The fold mirror, which is arranged in the secondary light transmission path, reflects the output image along a tertiary light transmission path as a HUD image. The PFO device is programmed to locally control a wave front characteristic of the output image to compensate for the curvature and rake angle when the HUD system displays the HUD image via a HUD patch.

### INTRODUCTION

A head-up display (HUD) system may be used aboard a vehicle to present information proximate an operator's forward-facing line-of-sight. Using a HUD system, the operator is able to freely view real-time vehicle information of types normally communicated via instrument panel gauges or a center console screen. For instance, a HUD system may display a current vehicle speed and heading, or graphics such as lane boundary markings, lane departure or obstacle detection warnings, etc. Projection of such information into or near the operator's line-of-sight allows the operator to view the displayed information without diverting attention from the roadway or other travel path.

An in-vehicle HUD system typically includes a dashboard-embedded projector that directs a light-based image toward a reflective fold mirror. The projected image is reflected via the fold mirror onto an aspheric mirror, which in turn directs the image toward a designated area of the windshield. This designated area, which is referred to herein and in the art as a HUD patch, may include a planar piece of reflective glass or plastic, or possibly a coated inner surface portion of the windshield. To the vehicle operator, the projected image may appear to seamlessly float in front of the windshield.

### SUMMARY

Disclosed herein is a head-up display (HUD) system for a vehicle, e.g., a motor vehicle, aircraft, spacecraft, rail vehicle/train, marine vessel/boat, or another mobile system having a windshield. The HUD system of the present disclosure includes a programmable freeform optics (PFO) device as part of its construction, which is used to facilitate use of the HUD system across a wide range of vehicle models each having a differently configured windshield.

As appreciated in the art, the surface curvature, rake angle, and other geometry of an installed windshield tends to vary between vehicle models. The non-planar surface of an installed windshield often distorts or defocuses light passing therethrough, and may cause other aberrations. The above-noted aspheric mirror is typically used to correct for such aberrations when projecting light-based information using a HUD system. However, aspheric mirrors are uniquely tailored to the particular curvature and rake angle of the installed windshield. As a result, HUD systems are commonly customized for use in vehicles of a given make or model. The present solutions are intended to enable a given HUD system to be used across a wide range of vehicle models, regardless of windshield configuration, thus addressing many of the manufacturing inefficiencies associated with the HUD system redesign process.

The solutions described herein replace the aspheric mirror of a typical HUD system with the PFO device. The PFO device in its various configurations forms a controllable hardware element that facilitates calibration and permits local correction of a light transmission path between the PFO device and a downstream fold mirror. Among other attendant benefits, the non-transitory computer-readable storage medium/memory of the PFO device is rewritable, thus enabling the disclosed HUD system to be shared across a wide range of vehicle models as noted above.

In accordance with a particular embodiment, the HUD system is disclosed for use with a windshield having a predetermined curvature and rake angle. The HUD system includes the HUD projector, PFO device, and fold mirror. The HUD projector is configured to project an input image along a primary light transmission path. The PFO device, which is positioned in the primary light transmission path, reflects or transmits the input image as an output image. This occurs along a secondary light transmission path. The fold mirror is arranged in the secondary light transmission path and is configured to reflect the output image along a tertiary light transmission path, with this reflected light forming a HUD image. The PFO device as set forth herein is programmed to locally control a wave front characteristic of the output image to compensate for the curvature and rake angle when the HUD system displays the HUD image on a HUD patch. The HUD patch in turn may be part of the HUD system in some configurations, possibly including the HUD patch being located on an inner surface of the windshield.

The PFO device in one or more embodiments includes a reflective element such as a liquid crystal-based mirror, e.g., a liquid crystal-on-silicon (LCoS)-based mirror or a piston-mode spatial light modulator having an array of individually-controllable micro-mirrors. In other embodiments the PFO device may include a transmissive element.

A processor may be configured to maintain the optical profile of the PFO device during operation of the HUD system, such that the optical profile does not deviate from a recorded baseline over a life of the HUD system.

A motor vehicle is also disclosed herein. In a possible configuration, the motor vehicle includes a vehicle body defining a vehicle interior, one or more road wheels connected to the vehicle body, a windshield, and a HUD system. The windshield is connected to the vehicle body and has a predetermined curvature and rake angle. The HUD system in this embodiment is operable for displaying a HUD image within the vehicle interior, and includes a HUD projector configured to project an input image along a primary light transmission path, a HUD patch arranged on the windshield or in proximity thereto, and a PFO device positioned in the primary light transmission path.

The PFO device in this embodiment reflects or transmit the input image along a secondary light transmission path as an output image using a recorded optical profile. Additionally, a fold mirror is arranged in the secondary light transmission path, with the fold mirror being configured to reflect the output image along a tertiary light transmission path as a HUD image. The PFO device is programmed to locally control a wave front characteristic of the output image to compensate for the curvature and rake angle when the HUD system displays the HUD image via the HUD patch.

Another aspect of the disclosure includes a method for calibrating a HUD system for use with a windshield having a predetermined curvature and rake angle. The method in accordance with an exemplary embodiment includes projecting an input test image along a primary light transmission path using a HUD projector of the HUD system. The method also includes reflecting or transmitting the input test image along a secondary light transmission path as an output image using a recorded optical profile, via a PFO device positioned in the primary light transmission path.

Additionally, the method includes reflecting the output image along a tertiary light transmission path as a HUD image using a fold mirror, and also determining, via a camera, a translational shift and displayed size of the test graphic relative to a respective target location and a target area on a HUD patch of the HUD system. As part of the method, an optical profile is recorded in a non-transitory computer-readable storage medium (memory) of the PFO device, with the optical profile, when executed, eliminating the translational shift and matching the target area. The method also includes executing the optical profile from the memory of the PFO device during operation of the HUD system.

The method may include maintaining the optical profile of the PFO device during operation of the HUD system, such that the optical profile does not deviate from a recorded baseline over a life of the HUD system.

Projecting the input test image along a primary light transmission path includes displaying the input test image on an inner surface of the windshield, with the HUD patch possibly located on the inner surface of the windshield.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 illustrates a motor vehicle equipped with a head-up display (HUD) system having a programmable freeform optics (PFO) device in accordance with the present disclosure.

FIG. 2 illustrates the PFO device of FIG. 2 in accordance with a possible embodiment.

FIGS. 3A, 3B, 3C, and 3D illustrate non-limiting representative implementations of the PFO device shown in FIG. 2.

FIG. 4 is a flow chart describing a calibration method for the HUD system of FIGS. 1 and 2 in accordance with an embodiment.

The appended drawings are not necessarily to scale, and may present a simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments may be arranged in a variety of configurations. Thus, the following detailed description is not intended to limit the scope of the disclosure as claimed, but is merely representative of possible embodiments thereof. In addition, while numerous specific details are set forth in the following description to provide a thorough understanding of various representative embodiments, some embodiments may be capable of being practiced without some of the disclosed details. Moreover, in order to improve clarity, certain technical material understood in the related art has not been described in detail. Furthermore, the disclosure as illustrated and described herein may be practiced in the absence of an element that is not specifically disclosed herein.

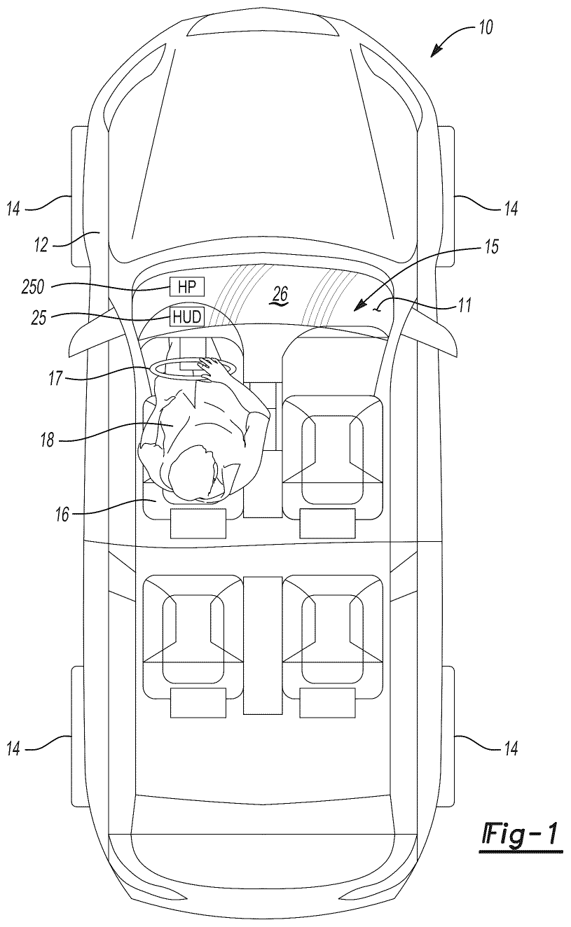

Referring now to the drawings, wherein like reference numbers refer to like features throughout the several views, FIG. 1 depicts a vehicle 10 having a vehicle body 12 defining a vehicle interior 15. A windshield 11 is connected to the vehicle body 12. The vehicle 10 may be variously embodied as a motor vehicle as shown, i.e., having a set of road wheels 14 and one or more propulsion sources (not shown) such as an internal combustion engine and/or an electric traction motor. In other configurations, the vehicle 10 may be constructed as an aircraft, spacecraft, motorcycle, train/rail vehicle, boat/marine vessel, etc. The present teachings are therefore not limited to the example of FIG. 1. For illustrative consistency, the vehicle 10 will be described hereinbelow as a motor vehicle 10, without limitation.

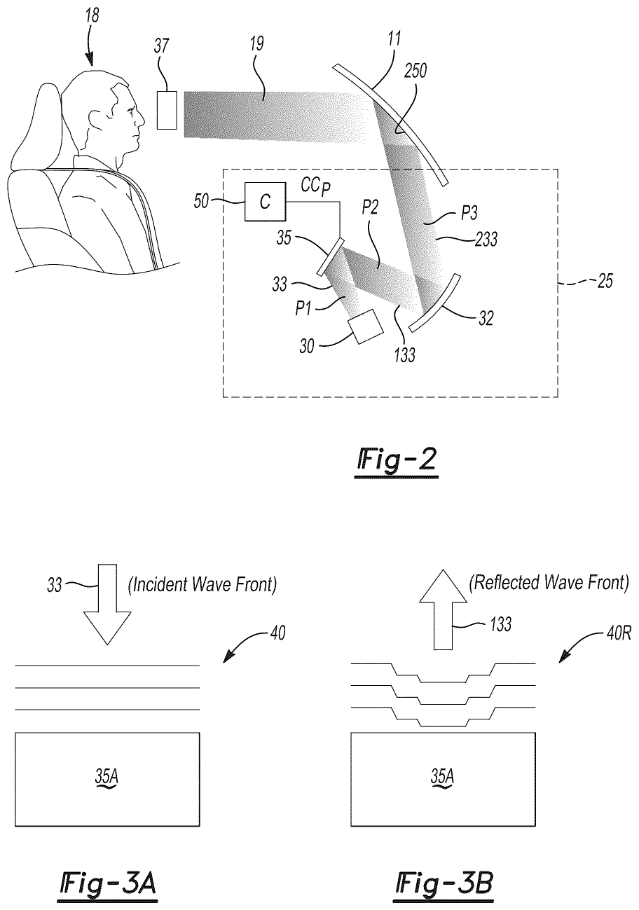

The motor vehicle 10 of FIG. 1 includes a head-up display (HUD) system 25, a non-limiting example embodiment of which is shown in FIG. 2. In the illustrated implementation of FIG. 1, the HUD system 25 is configured to project information onto the windshield 11, or more specifically onto a HUD patch (HP) 250 located on or in proximity to the windshield 11. An operator 18 in the non-limiting embodiment of FIG. 1 is shown in a forward-facing position in a driver's seat 16, with the operator 18 being seated behind a steering wheel 17. Information projected onto the HUD patch 250 is thus presented near or along a normal forward facing line-of-sight of the operator 18 for easy/non-distracted viewing of the displayed information.

The construction of the HUD patch 250 may vary with the particular design of the HUD system 25. For example, the HUD patch 250 may be a coated portion of the windshield 11 for a windshield-projected implementation, or the HUD patch 250 may be implemented as a deployable “pop-up” screen, a combiner screen, a fixed panel, or an augmented reality (AR) display in possible embodiments. The latter AR embodiment may be particularly useful for overlaying icons, images, or other graphics onto a real-world view of the travel path visible to the operator 18 through the windshield 11.

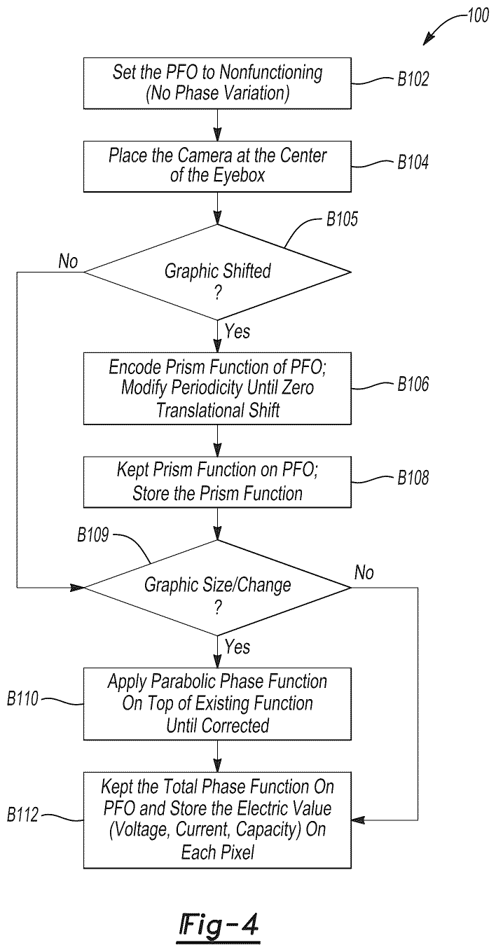

Referring to FIG. 2, the HUD system 25 is illustrated in accordance with a representative construction. As contemplated herein, the HUD system 25 is installed in proximity to the windshield 11 (also shown in FIG. 1), such as below/behind a dashboard 26. In the non-limiting implementation of FIG. 2, the operator 18, or a camera 37 during the calibration method 100 of FIG. 4, views the HUD patch 250 located on or near an inner surface of the windshield 11. The three-dimensional (3D) volume within which the driver's eyes are located in order to properly view projected information on the HUD patch 250 is referred to as the eye box 19. The eye box 19 of FIG. 2 thus bounds an area in which the eyes of the operator 18 are able to move while maintaining a clear view of the displayed information, e.g., without distortion or loss of field/image cutoff.

As appreciated in the art, the windshield 11 is installed on the motor vehicle 10 of FIG. 1 with a corresponding curvature (arc) and rake angle, i.e., the angle formed between the installed windshield 11 and a vertical line arranged normal to a ground plane. The size and surface geometry of the windshield 11 provides a vehicle make/model with a desired level of aerodynamic performance and strength, and also increases or reduces available headroom within the vehicle interior 15 of FIG. 1. Thus, motor vehicles 10 of different makes or models often are equipped with windshields 11 with different curvatures and/or rake angles. As noted above, this reality complicates the reuse of typical HUD system hardware elements across vehicle platforms.

To mitigate manufacturing problems associated with this lack of reusability, the HUD system 25 of FIG. 2 is equipped with a programmable freeform optics (PFO) device 35 that enables a manufacturer of the motor vehicle 10 (FIG. 1) to modify optical properties of the HUD system 25 during calibration so as to achieve a desired optical performance. Use of the PFO device 35 as set forth below enables in-facility calibration of the HUD system 25 to a given windshield 11. Optical performance of the HUD system 25 is achieved via simple programming inputs, with an exemplary calibration approach described below with reference to FIG. 4.

In the illustrated implementation of FIG. 2, the HUD system 25 includes a HUD projector 30, the PFO device 35, and a fold mirror 32. The HUD projector 30 may be embodied as a light-emitting diode (LED) array, or as a liquid crystal display (LCD), organic light-emitting diode (OLED) displays, quantum dot displays, etc. The HUD projector 30 is thus constructed as a light display operable for generating and projecting light-based information, i.e., an input image 33, along a primary light transmission path (P1) toward the PFO device 35. The PFO device 35 also includes or is connected to a controller (C) 50 as described below, and may be connected to a picture generation unit or other device operable for controlling the context of the generated information. The PFO device 35 then directs a corrected output image 133 along a secondary image transmission path (P2).

The fold mirror 32 is operable for folding or redirecting the output image 133 from the PFO device 35 as a HUD image 233, which occurs over a tertiary light transmission path (P3). This HUD image 233 is ultimately directed toward the windshield 11 (or HUD patch 250) by the fold mirror 32. As used herein, the terms primary, secondary, and tertiary are used to indicate sequential positions of the light paths (P1, P2, P3) relative to the HUD projector 30, i.e., with the primary and tertiary light transmission paths (P1 and P3) respectively located closest and farthest from the HUD projector 30.

In one or more embodiments, the fold mirror 32 may be constructed as a reflective piece of curved or planar material. Exemplary materials of construction include, e.g., optical glass or high-quality plastic with an aluminum, silver, or other highly-reflective coating, dielectric mirrors, etc. Due to physical packaging constraints of the dashboard 26/instrument panel area noted above, use of the fold mirror 32 allows the HUD projector 30 to be positioned in a space-optimal location. More than one fold mirror 32 may be used in other implementations, and therefore the representative construction of FIG. 2 is non-limiting.

The controller 50 of the PFO device 35 may be equipped with one or more processors 52 and a non-transitory computer-readable storage medium 54, i.e., memory 54. The memory 54 is rewritable, and is programmable via an optical profile (CC_{P}) as set forth below. This feature allows the PFO device 35 to be configured in logic for a given windshield 11 as noted above. The processor 52 in one or more embodiments may be configured for maintaining the optical profile (CC_{P}) of the PFO device 35 during operation of the HUD system 25, such that the optical profile (CC_{P}) does not deviate from a recorded baseline over a life of the HUD system 25. The memory 54 may include memory chips or circuits, e.g., magnetic or optical media, CD-ROM, solid-state/semiconductor memory (e.g., RAM or ROM), etc. The processor 52 may be constructed from various combinations of Application Specific Integrated Circuit(s) (ASICs), Field-Programmable Gate Arrays (FPGAs), electronic circuits, central processing units, e.g., microprocessors, and the like.

Non-transitory components of the memory 54 are capable of storing machine-readable instructions in the form of one or more software or firmware programs or routines, combinational logic circuit(s), input/output circuit(s) and devices, signal conditioning and buffer circuitry and other components that can be accessed by one or more processors 52 to maintain, e.g., a phase profile of the PFO device 35 during use of the HUD system 25 in some embodiments. Input/output circuits and devices for use with the actuator control unit 50 may include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables.

The PFO device 35 of FIG. 2 may be controlled to produce different wave fronts. To that end, the construction of the PFO device 35 may vary with the intended application. In general, the PFO device 35 may include a freeform optical surface that is controlled to deviate from purely aspheric or spherical shapes. Embodiments of the PFO device 35 within the scope of the disclosure may include at least one reflective element or at least one transmissive element, with the former option being a more mature and thus commercially available option. To implement the latter, i.e., a transmissive element, the PFO device 35 may include materials such as fused silica, calcium fluoride, optical polymers, etc., which may provide packaging space advantages due to the smaller size of transmissive elements relative to reflective elements. In a transmissive element embodiment, the PFO device 35 may include at least one transmissive element that allows incident light to pass through while actively controlling the wave front and/or phase profiles of transmitted light, for instance by manipulating a refractive index distribution, thickness, and/or surface profile.

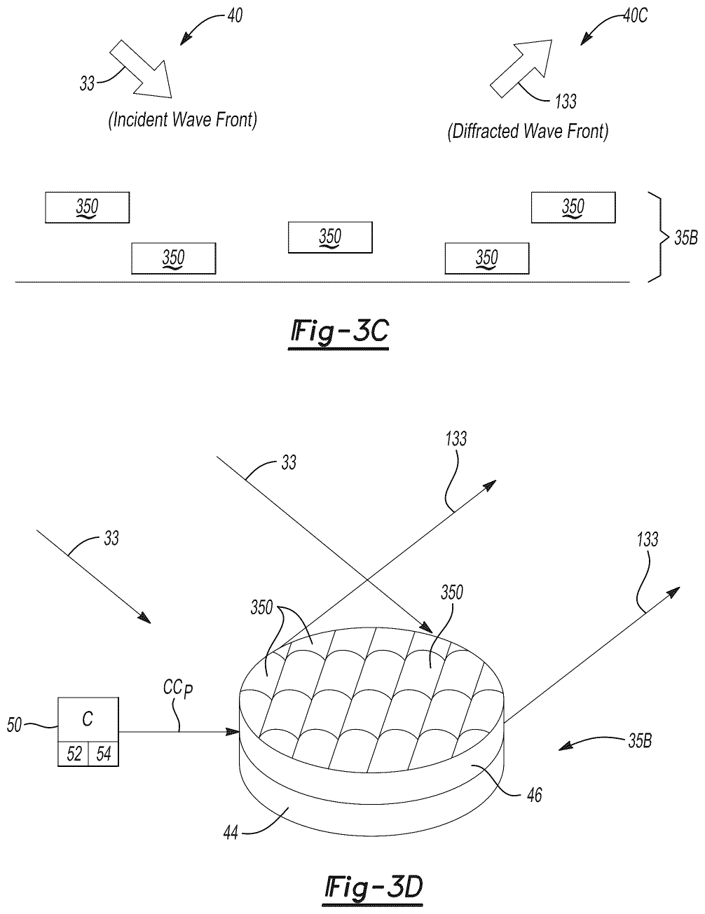

As illustrated in FIG. 3A, an incident wave front 40 of the light-based input image 33 from the HUD projector 30 of FIG. 2 propagates along the primary light transmission path (P1) toward the PFO device 35, which in the FIG. 3A embodiment is represented as PFO device 35A, i.e., a reflective element. The PFO device 35A is optionally embodied as liquid crystal-based mirror or reflective optic, e.g., a liquid crystal-on-silicon (LCoS) mirror or optic piece having a silicon chip/backplane of miniature mirrors as appreciated in the art. Each LCoS-based mirror corresponds to one pixel of the image/icon or other information. Crystal orientation of a liquid crystal material residing on the backplane may be controlled to modulate light from the HUD projector 30 of FIG. 2, with other possible components such as polarizers and waveplates used to control the optical properties of light. As shown in FIG. 3B, for example, the output image 133 forming a reflected wave front 40R propagates away from the PFO device 35A toward the fold mirror 32 of FIG. 2, with the reflected wave front 40R having different optical properties than the incident wave front 40 of FIG. 3A, for instance a different phase.

Referring to FIGS. 3C and 3D, another PFO device 35B may be alternatively configured as reflective piston-mode spatial light modulator having an array of individually-controllable micro-mirrors 350. Such a variant may be used to modulate the incident light of the input image 33 from the HUD projector 30 of FIG. 2, e.g., phase, amplitude, and/or polarization. In such an implementation, an array of micrometer size (or smaller) micro-mirrors 350 are arranged on different planes (FIG. 3C). The input image 33 forming the incident wave front 40 is directed by the HUD projector 30 (FIG. 2) along the primary light transmission path (P1) of FIG. 2 toward the array of micro-mirrors 350. The micro-mirrors 350 reflect or diffract the light of the input image 33 as the output image 133, the latter forming a corrected wave front 40C. This is reflected from the fold mirror 32 toward the windshield 11/HUD patch 250 to form the HUD image 233 of FIG. 2.

The PFO device 35B of FIGS. 3C and 3D may be constructed with a flexible/deformable mirror surface, and/or using electroactive materials, with the mirror surface formed from the array of micro-mirrors 350. Such a mirror surface may be shaped or contoured using an actuator assembly 46, with the actuator assembly 46 mounted to a base 44 in a possible construction. The controller 50 may be connected to or in communication with the actuator assembly 46 and configured to individually control a corresponding state of each respective one of the micro-mirrors 350. For example, the controller 50 may apply a calibrated electric field to cause a desired refractive index changes or surface deformation of each of the micro-mirrors 350, thereby controlling the optical properties and wave front characteristics of corrected wave front 40C.

Referring to FIG. 4, the method 100 may be implemented in a manufacturing facility, repair depot, or other suitable environment when configuring the HUD system 25 of FIG. 1 for use with a particular windshield 11, i.e., one connected to vehicle body 12 of FIG. 1 and having a predetermined surface curvature and rake angle. The method 100 is illustrated as a series of execution and decision blocks. The blocks may be performed using manual and/or automated process steps to calibrate the PFO device 35 of FIG. 2 for use with the windshield 11, i.e., without having to replace an aspheric mirror of the type noted elsewhere above or other hardware of the HUD system 25.

Beginning with block B102, with the HUD 25 installed in the motor vehicle 10 relative to the windshield 11 of FIG. 1, the PFO device 35 is set to a default non-functioning state. Using a working example in which the PFO device 35 is configured to vary phase of light forming the input image 33, block B102 may entail setting the optical profile (CC_{P}) of the PFO device 35, via the controller 50, such that phase variation of light forming the input image 33 does not occur. The method 100 proceeds to block B104.

Block B104 includes placing the camera 37 (FIG. 2) along a center axis of the eye box 19, i.e., at eye level of the operator 18 at the expected location of the operator's eyes when seated in the vehicle interior 15 of FIG. 1. Commercially available cameras usable for this purpose include, e.g., complimentary metal-oxide-semiconductor (CMOS) digital cameras acting as image sensors to capture digital pixel data of the displayed test image, i.e., a test version of the HUD image 233 of FIG. 2, or graphic variant of the HUD image 233. The placement location of the camera 37 corresponds to a stereo viewing point of the operator 18, and thus the camera 37 acts as a proxy for the operator 18 for the purpose of calibration. Block B104 also includes projecting the input image 33, in this case as an input test image, along a primary light transmission path (P1) using the HUD projector 30 of the HUD system 25. The method 100 proceeds to block B105 once the camera 37 has been properly positioned and the input image 33 (test image) is projected toward the PFO device 35.

At block B105 of FIG. 4, the method 100 includes reflecting or transmitting the input image 33 along the secondary light transmission path (P2) as the output image 133 (FIG. 2) using the recorded optical profile (CC_{P}), which was initially set to a default non-functioning state in block B102. Reflection/transmission in block B105 occurs via the PFO device 35, which is positioned in the primary light transmission path (P2) as depicted in FIG. 2. Block B105 also includes reflecting the output image 133 along the tertiary light transmission path (P3) as the HUD image 233 using the fold mirror 32 of FIG. 2.

Additionally, block B105 includes determining an amount of translational shift and a displayed size of the test version of the HUD image 233 relative to a respective target location and target area on the HUD patch 250. For example, block B105 may entail determining if the HUD image 233 (test graphic) from block B104 is translated or shifted relative to a predefined target area of corresponding pixels on the windshield 11 or HUD patch 250. Block B105 may include using computer vision software in some implementations, such that a position of the displayed test graphic is compared to predetermined coordinates of the desired target area, e.g., a single point or a defined display area constructed of multiple points. The method 100 proceeds to block B106 when the test graphic, i.e., the displayed HUD image 233 used during calibration, is translated/shifted relative to the target area, and to block B109 in the alternative when the test graphic is not translated/shifted relative to the target area.

Block B106 entails adjusting a state of the PFO device 35 via adjustment of the optical profile (CC_{P}) until test graphic is no longer translated/shifted relative to the target area to shift the beam forming the secondary light transmission path (P2) of FIG. 2, e.g., using a linear phase variation. Adjustment of the optical profile (CC_{P}) may include adjusting a corresponding prism function for the PFO device 35 via the controller 50, modifying periodicity or other characteristics of the PFO device 35 until the test graphic no longer exhibits a translational shift, etc. The method 100 thereafter proceeds to block B108.

At block B108, the method 100 includes storing the optical profile (CC_{P}) or function from block B106 in memory 54 of the controller 50. The updated optical profile (CC_{P}), when executed by the controller 50, would eliminate the translational shift and match the target area, such that the PFO device 35 maintains the desired position of the test graphic. The method 100 thereafter proceeds to block B109.

Block B109 includes determining whether the test graphic has changed in size, i.e., shrunk or grown relative to a desired size. As with block B105, this decision may be made in logic of the controller 50 by comparing a true pixel area of the displayed test graphic—the displayed HUD image 233 used during calibration—to a predetermined pixel area to determine if the two areas match to within a permissible application-specific tolerance. The method 100 proceeds to block B110 when the displayed size of the test graphic is reduced (or enlarged) relative to the predetermined size. The method 100 proceeds to block B112 in the alternative when the test graphic is the correct size, i.e., matches the predetermined size in terms of its number of image pixels or other criteria.

At block B110, with the test graphic of block B109 determined as having shrunk (or grown) relative to its predetermined or desired size, the method 100 may apply a one-dimensional or two-dimensional parabolic total phase function on top of the existing shift-correcting function previously stored at block B108. This additional total phase function is maintained until the size difference is eliminated. The method 100 thereafter proceeds to block B112.

Block B112 includes maintaining the phase profile of the PFO device, e.g., the total phase function, and storing its corresponding state, e.g., voltage, current, capacity, etc., for each of the constituent pixels of the test graphic. Calibration is thus complete, and therefore the camera 37 of FIG. 2 is removed. Display of the test graphic is discontinued. The HUD system 25 is therefore made ready for use with windshields 11 having the same surface curvature and rake angle as the windshield 11 used to calibrate the PFO device 35.

As will be appreciated by those of ordinary skill in the art, now having the benefit of the present teachings, the use of the PFO 35 described herein, representative embodiments of which are illustrated in FIGS. 2-3D, enables programming-based compensation for differences in surface curvature and rake angle of the windshield 11 shown in FIGS. 1 and 2. The HUD system 25 is characterized by an absence of the above-noted aspheric mirror. Instead, the HUD system 25 uses the PFO 35 places the fold mirror 32 in a place normally occupied by the aspheric mirror, and the PFO 35 in the place normally occupied by the fold mirror 32. With such a HUD system 25 in place, the calibration method 100 of FIG. 4 may be used to enable installation of a given HUD system 25 across a wide range of different vehicle models, thus eliminating the myriad of potential manufacturing problems and inefficiencies associated with aspheric mirror-related redesign requirements. These and other benefits of the present disclosure will be readily appreciated in view of the foregoing disclosure.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed is:

1. A head-up display (HUD) system for use with a windshield having a predetermined curvature and rake angle, comprising:
a HUD projector configured to project an input image along a primary light transmission path;
a programmable freeform optics (PFO) device positioned in the primary light transmission path, the PFO device being configured to reflect or transmit the input image along a secondary light transmission path as an output image using a recorded optical profile; and
a fold mirror arranged in the secondary light transmission path, the fold mirror being configured to reflect the output image along a tertiary light transmission path as a HUD image, wherein the PFO device is programmed to locally control a wave front characteristic of the output image to compensate for the curvature and rake angle when the HUD system displays the HUD image via a HUD patch.

2. The HUD system of claim 1, wherein the PFO device includes a reflective element.

3. The HUD system of claim 2, wherein the reflective element includes a liquid crystal-based mirror.

4. The HUD system of claim 3, wherein the liquid crystal-based mirror includes a liquid crystal-on-silicon (LCoS)-based mirror.

5. The HUD system of claim 2, wherein the reflective element includes a piston-mode spatial light modulator having an array of individually-controllable micro-mirrors.

6. The HUD system of claim 1, wherein the PFO device includes a transmissive element.

7. The HUD system of claim 1, further comprising: a processor configured to maintain the optical profile of the PFO device during operation of the HUD system, such that the optical profile does not deviate from a recorded baseline over a life of the HUD system.

8. The HUD system of claim 1, further comprising: the HUD patch.

9. The HUD system of claim 8, wherein the HUD patch is located on an inner surface of the windshield.

10. A motor vehicle comprising:
a vehicle body defining a vehicle interior;
one or more road wheels connected to the vehicle body;
a windshield connected to the vehicle body, the windshield having a predetermined curvature and rake angle; and
a head-up display (HUD) system operable for displaying a head-up display (HUD) image within the vehicle interior, the HUD system comprising:
a head-up display (HUD) projector configured to project an input image along a primary light transmission path;
a HUD patch arranged on the windshield or in proximity thereto;
a programmable freeform optics (PFO) device positioned in the primary light transmission path, the PFO device being configured to reflect or transmit the input image along a secondary light transmission path as an output image using a recorded optical profile; and
a fold mirror arranged in the secondary light transmission path, the fold mirror being configured to reflect the output image along a tertiary light transmission path as a HUD image, wherein the PFO device is programmed to locally control a wave front characteristic of the output image to compensate for the curvature and rake angle when the HUD system displays the HUD image via the HUD patch.

11. The motor vehicle of claim 10, wherein the PFO device includes a reflective element.

12. The motor vehicle of claim 11, wherein the reflective element includes a liquid crystal-based mirror.

13. The motor vehicle of claim 12, wherein the liquid crystal-based mirror includes a liquid crystal-on-silicon (LCoS)-based mirror.

14. The motor vehicle of claim 11, wherein the reflective element includes a piston-mode spatial light modulator having an array of individually-controllable micro-mirrors.

15. The motor vehicle of claim 10, wherein the PFO device includes a transmissive element.

16. The motor vehicle of claim 10, further comprising:
a processor configured to maintain the optical profile of the PFO device during operation of the HUD system, such that the optical profile does not deviate from a recorded baseline over a life of the HUD system.

17. A method for calibrating a head-up display (HUD) system for use with a windshield having a predetermined curvature and rake angle, the method comprising:
projecting an input test image along a primary light transmission path using a HUD projector of the HUD system;
reflecting or transmitting the input test image along a secondary light transmission path as an output image using a recorded optical profile, via a programmable freeform optics (PFO) device positioned in the primary light transmission path;
reflecting the output image along a tertiary light transmission path as a HUD image using a fold mirror;
determining, via a camera, a translational shift and displayed size of the test graphic relative to a respective target location and a target area on a HUD patch of the HUD system;
recording an optical profile in a non-transitory computer-readable storage medium (memory) of the PFO device, the optical profile, when executed, eliminating the translational shift and matching the target area; and
executing the optical profile from the memory of the PFO device during operation of the HUD system.

18. The method of claim 17, wherein the PFO device includes a reflective element, and wherein reflecting or transmitting the input test image along the secondary light transmission path is performed using the reflective element.

19. The method of claim 17, further comprising:
maintaining the optical profile of the PFO device during operation of the HUD system, such that the optical profile does not deviate from a recorded baseline over a life of the HUD system.

20. The method of claim 17, wherein projecting an input test image along a primary light transmission path includes displaying the input test image on an inner surface of the windshield, and wherein the HUD patch is located on the inner surface of the windshield.
